(19) United States
(12) Patent Application Publication
(10) Pub. No.: US 2025/0100629 A1
(43) Pub. Date: Mar. 27, 2025

(54) LEVEL DECK CAPTIVATED BEAM SYSTEM AND METHOD

(71) Applicant: Steven E. Downing, Beaver Dam, WI (US)

(72) Inventor: Steven E. Downing, Beaver Dam, WI (US)

(21) Appl. No.: 18/896,835

(22) Filed: Sep. 25, 2024

Related U.S. Application Data
(60) Provisional application No. 63/585,035, filed on Sep. 25, 2023.

(51) Int. Cl. B62D 33/04; B60P 7/08

(52) U.S. Cl. CPC B62D 33/042; B60P 7/0823

(57) ABSTRACT

A deck leveling system may include a track, a beam, a first foot assembly and/or a second foot assembly. The first and second foot assembles may be connected to the beam and may be configured to move along the track. The beam and the first and second foot assemblies may be configured to move relative to the track when the first and second foot assembles are in an unlocked state. The beam may be positioned perpendicular relative to the track when the first and second foot assembles are in a locked state. The beam may be in a position that is not perpendicular relative to the track when the first and second foot assembles are in the unlocked state.

### CROSS-REFERENCE TO RELATED APPLICATIONS

This application claims priority to U.S. Provisional Patent Application No. 63/298,910, filed on Jan. 12, 2022, and U.S. patent application Ser. No. 18/096,370, filed Jan. 12, 2023, and U.S. Provisional Patent Application No. 63/585,035 filed Sep. 25, 2023, the contents of which is hereby incorporated by reference in its entirety.

### TECHNICAL FIELD

The present disclosure generally relates to storage systems for use in cargo trailers, and in particular, to an improved system for adjusting and/or leveling the decking system in a cargo trailer.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some decking systems may not provide sufficient functionality, are difficult to adjust and/or level, and/or required complicated assembly processes.

There is a desire for solutions/options that minimize or eliminate one or more challenges or shortcomings of decking systems. The foregoing discussion is intended only to illustrate examples of the present field and is not a disavowal of scope.

### OVERVIEW

In the embodiments, a system may include a track, a beam, a first foot assembly and/or a second foot assembly. The first and second foot assembles may be connected to the beam and may be configured to move along the track. The beam and the first and second foot assembles may be configured to move relative to the track when the first and second foot assembles are in an unlocked state. The beam may be positioned perpendicular relative to the track when the first and second foot assembles are in a locked state. The beam may be in a position that is not perpendicular relative to the track when the first and second foot assembles are in the unlocked state.

In another embodiment, the system may be operated by an operator releasing a first foot assembly without any tool such that the foot assembly moves vertically within a track to a desired vertical position, and then self-locks. Once the operator releases the first foot assembly, said assembly may automatically lock relative to the track. The operator may separately release a second foot assembly and it may traverse vertically within a second track to a desired position. When the operator releases the foot assembly it automatically engages the track and maintains its position.

The foregoing and other potential aspects, features, details, utilities, and/or advantages of examples/embodiments of the present disclosure will be apparent from reading the following description, and from reviewing the accompanying drawings.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is an end view generally illustrating an embodiment of a captivated beam deck leveling system according to teachings of the present disclosure.

FIG. 2 is a top view generally illustrating an embodiment of a system according to teachings of the present disclosure.

FIG. 3 is an exploded perspective view generally illustrating an embodiment of a foot assembly of a system according to teachings of the present disclosure.

FIG. 4 is a side view generally illustrating portions of embodiments of a foot assembly of a system according to teachings of the present disclosure.

FIG. 5 is a perspective view generally illustrating portions of embodiments of a foot assembly of a system according to teachings of the present disclosure.

FIG. 6 is a partial perspective view generally illustrating a foot assembly and a beam according to teachings of the present disclosure.

FIG. 7 is another partial perspective view generally illustrating a foot assembly and a beam according to teachings of the present disclosure.

FIG. 8 is yet another partial perspective view generally illustrating the underside of a foot assembly and a beam according to teachings of the present disclosure.

FIG. 9 is side view generally illustrating portions of a foot assembly and a beam according to teachings of the present disclosure.

FIG. 10 is a flowchart generally illustrating a method of operating the system show in FIG. 1.

FIG. 11 is an alternative deck leveling system, shown in a stored position, where three beams are connected together and they are operable to move together relative to a track system mounted to side walls of a trailer.

FIG. 12 is the deck leveling system, shown with a composite panel in the pulled down position.

FIG. 13 is the deck leveling system, shown with three beams in a pulled down position.

FIG. 14 is a side view of the deck leveling system, showing a beam mounted to two side walls of a trailer.

FIG. 15 is a top view of the deck leveling system, showing three beams mounted to two side walls of a trailer.

FIG. 16. is a perspective view of the foot assemblies of three beams, shown mounted to three vertical tracks positioned on a vertical wall of one side of a trailer.

FIG. 17 is a perspective view of a foot assembly.

FIG. 18 is an exploded perspective view of the components of a foot assembly.

FIG. 19 is a side view of a foot assembly.

FIG. 20 is a side view of a foot assembly, showing internal components.

FIG. 21 is a side view of a foot assembly, showing internal components.

FIG. 22 is a side view of a foot assembly, showing internal components.

FIG. 23 is a perspective view of a foot assembly, showing internal components.

FIG. 24 is a perspective view of a foot assembly, showing internal components.

FIG. 25 is an inside view of the housing for the foot assembly.

FIG. 26 is an inside view of the housing for the foot assembly.

FIG. 27 is a flow chart of the method of operating the deck leveling assembly.

### DETAILED DESCRIPTION

Reference will now be made in detail to embodiments of the present disclosure, examples of which are described herein and illustrated in the accompanying drawings. While the present disclosure will be described in conjunction with embodiments and/or examples, they do not limit the present disclosure to these embodiments and/or examples. On the contrary, the present disclosure covers alternatives, modifications, and equivalents.

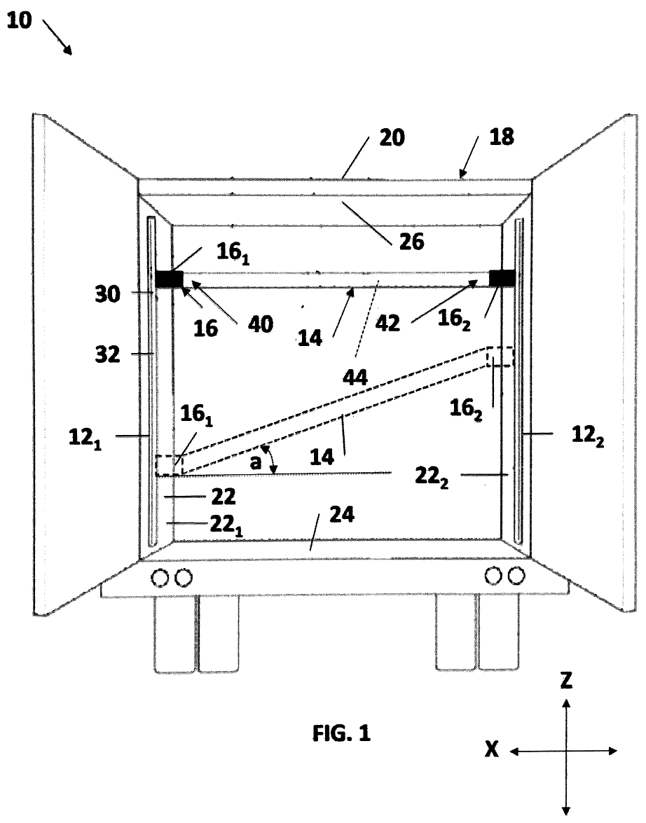

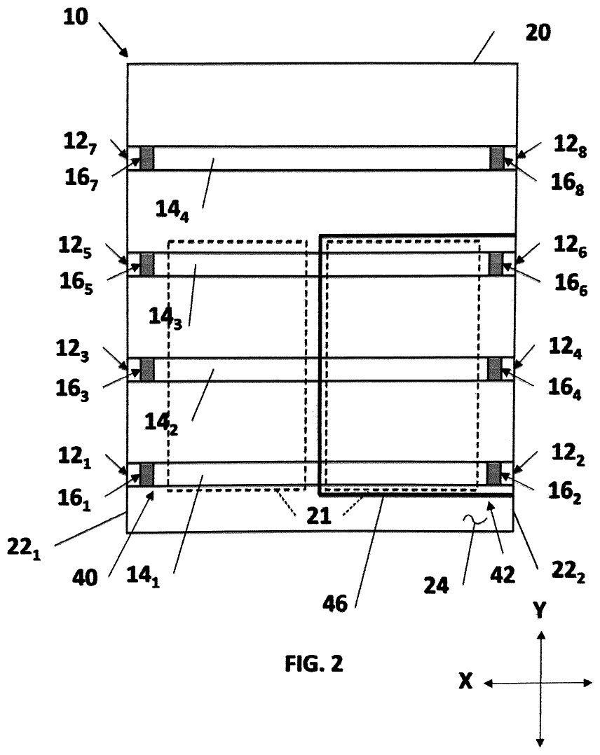

In embodiments, such as generally illustrated in FIGS. 1 and 2, a system 10 may include a plurality of tracks 12 (e.g., a first track 12₁, a second track 12₂, a third track 12₃, a fourth track 12₄, a fifth track 12₅, a sixth track 12₆, a seventh track 12₇, and/or an eighth track 12₈), a plurality of beams 14 (e.g., a first beam 14₁, a second beam 14₂, a third beam 14₃, and/or a fourth beam 14₄), a plurality of foot assemblies 16 (e.g., a first foot assembly 16₁, a second foot assembly 16₂, a third foot assembly 16₃, a fourth foot assembly 16₄, a fifth foot assembly 16₅, a sixth foot assembly 16₆, a seventh foot assembly 16₇, and/or an eighth foot assembly 16₈).

In some instances, the system 10 may be associated with a vehicle 18. For example, and without limitation, the system 10 may be disposed within a cargo trailer 20 of a vehicle 18. In some examples, the system 10 may not be associated with a vehicle 18 and/or may be disposed within a building (e.g., a warehouse, a storage facility, a manufacturing facility, among others), a ship, a rail car, a plane, or some other construct. The system 10 may be configured such that cargo 21 (e.g., pallets of goods) may be stacked upon, supported by, and/or secured to portions of the system 10. The system 10 may be configured to support heavy cargo 21.

With reference to the embodiments, a vehicle 18 may include one or more of a variety of configurations. For example, and without limitation, a vehicle 18 may include a land vehicle, a railroad car, a truck (e.g., a semi-truck, a commercial truck, a cargo truck, etc.), and/or a van, among others. A vehicle 18 may include and/or may be configured to haul the cargo trailer 20. In some example configurations, the cargo trailer 20 may include side walls 22, a floor 24, and/or a ceiling 26.

In some embodiments, a track 12 (e.g., tracks 12₁-12₈) may be secured (e.g., via fasteners, etc.) to side walls 22 of the cargo trailer 20. In an assembled configuration, a track 12 may extend in a direction (e.g., Z-direction) that is substantially perpendicular to the floor 24 and/or the ceiling 26 of the cargo trailer 20. A track 12 may be configured to receive portions of the foot assembly 16. In some instances, a track 12 may be elongated. A track 12 may include openings 30 for receiving a portion of a foot assembly 16 and/or a slot 32 that may extend along an entire length of the track 12. A track 12 may comprise a rigid material (e.g., metal, etc.). While the system 10 is shown including eight tracks, the system 10 may comprise more or less than eight tracks according to teachings of the present disclosure.

The system 10 may be customizable such that a user of the system 10 may arrange the tracks 12, the beams 14, and/or the foot assemblies 16 in various configurations. As generally illustrated in FIG. 2, the tracks 12 may be arranged within the cargo trailer 20 such that an equal number of tracks 12 are disposed on opposing side walls 22 (e.g., first side wall 22₁ and second side wall 22₂). The tracks 12 may be spaced on each side wall 22 such that tracks on one side wall (e.g., the first side wall 22₁) are aligned and/or correspond with tracks on the opposing side wall (e.g., the second side wall 22₂). For example, and without limitation, the first track 12₁, the third track 12₃, the fifth track 12₅, and/or the seventh track 12₇ may be disposed on the first side wall 22₁ and/or the second track 12₂, the fourth track 12₄, the sixth track 12₆, and/or the eighth track 12₈ may be disposed on the second side wall 22₂. The tracks 12 may be arranged such that the first track 12₁ is spaced apart from and/or opposes the second track 12₂, the third track 12₃ is spaced apart from and/or opposes the fourth track 12₄, the fifth track 12₅ is spaced apart from and/or opposes the sixth track 12₆, and/or the seventh track 12₇ is spaced apart from and/or opposes the eight track 12₈.

A beam 14 (e.g., beams 14₁₋₄) may include a first end 40 and a second end 42 spaced apart from the first end 40. A beam 14 may be elongated and/or hollow. For instance, a beam 14 may include an opening 44 that extends from the first end 40 to the second end 42. In some example configurations, a foot assembly 16 may be connected to and/or partially disposed within each of the first and second ends 40, 42. A beam 14 and/or a foot assembly 16 may be configured to move relative to a track 12. For example, and without limitation, the first foot assembly 16₁ may be connected to and/or partially disposed within a first end 40 of the first beam 14₁ and/or the second foot assembly 16₂ may be connected to and/or partially disposed within a second end 42 of the first beam 14₁. The third foot assembly 16₃ may be connected to and/or partially disposed within a first end 40 of the second beam 14₂ and/or the fourth foot assembly 16₄ may be connected to and/or partially disposed within a second end 42 of the second beam 14₂. The fifth foot assembly 16₅ may be connected to and/or partially disposed within a first end 40 of the third beam 14₃ and/or the sixth foot assembly 16₆ may be connected to and/or partially disposed within a second end 42 of the third beam 14₃. The seventh foot assembly 16₇ may be connected to and/or partially disposed within a first end 40 of the fourth beam 14₄ and/or the eighth foot assembly 16₈ may be connected to and/or partially disposed within a second end 42 of the fourth beam 14₄.

In the embodiments, each foot assembly 16 is connected to a corresponding track 12. For instance, the first foot assembly 16₁ may be connected to the first track 12₁, the second foot assembly 16₂ may be connected to the second track 12₂, the third foot assembly 16₃ may be connected to the third track 12₃, the fourth foot assembly 16₄ may be connected to the fourth track 12₄, the fifth foot assembly 16₅ may be connected to the fifth track 12₅, the sixth foot assembly 16₆ may be connected to the sixth track 12₆, the seventh foot assembly 16₇ may be connected to the seventh track 12₇, and/or the eighth foot assembly 16₈ may be connected to the eight track 12₈. Each foot assembly 16 may be selectively/releasably connected to (e.g., mechanically), move (e.g., slide) along and relative to, and/or be removed from the corresponding track 12. As generally illustrated in the figures, the system 10 is shown having a single beam coupled (e.g., indirectly) to opposing tracks, however more than one beam may be coupled to the same opposing tracks according to teachings of the present disclosure.

A beam 14 may engage at least a portion of the cargo 21. For instance, the cargo 21 may be stacked directly upon the beams 14. In some example configurations, at least two adjacent beams 14 may be utilized to support cargo 21. For example, and without limitation, the first beam 14₁, the second beam 14₂, the third beam 14₃ may support the same cargo 21. In some instances, the cargo 21 may be placed adjacent to additional cargo 21 such that the cargo 21 and the additional cargo 21 are supported by the same beams 14 (e.g., 14₁₋₃). In embodiments, a beam 14 may comprise a rigid material (e.g., a metal, etc.). In some example configurations, one or more external components 46 (e.g., straps, etc.) may be configured to secure the cargo 21 to portions of the system 10 (see, e.g., FIG. 2). For instance, one or more external components 46 may be used to prevent cargo 21 from moving relative to the beams 14. An external component 46 may wrap around at least a portion of the cargo 21 and connect to a side wall 22, a beam 14, and/or a track 12. The external components 46 may include various shapes, sizes, configurations, and/or materials. While the system 10 is shown including four beams, the system 10 may comprise more or less than four beams according to teachings of the present disclosure.

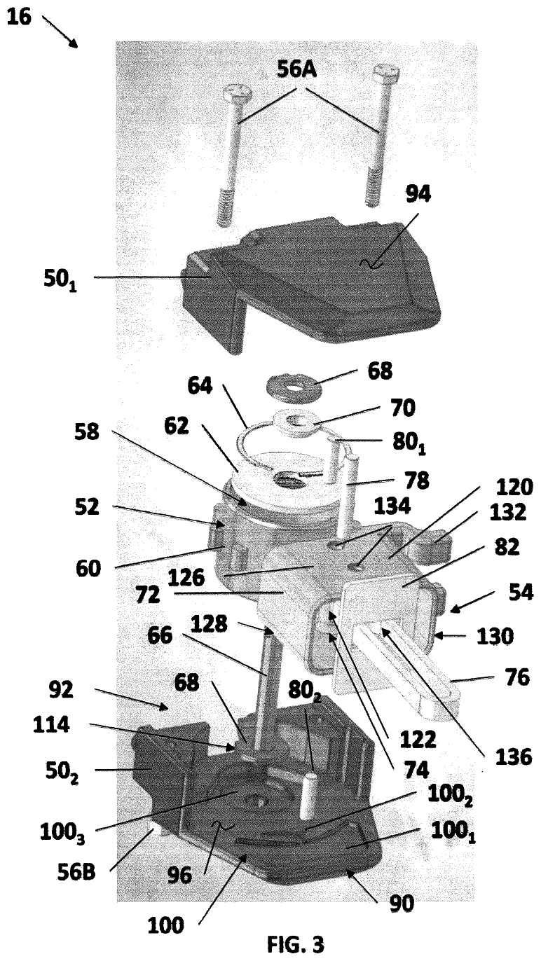

In one exemplary embodiment, such as generally illustrated in FIG. 3, a foot assembly 16 (e.g., foot assemblies 16₁₋₈) may include a first plate 50₁ (e.g., a first foot), a second plate 50₂ (e.g., a second foot), a power balancer assembly 52, and a release assembly 54. In an assembled configuration, the first plate 50₁ may be fixed to the second plate 50₂ such that a void is disposed between the first plate 50₁ and the second plate 50₂. The first plate 50₁ may be fixed to the second plate 50₂ via one or more fasteners 56 (e.g., a bolt 56A and nut 56B, among others). The power balancer assembly 52 and/or the release assembly 54 may be at least partially disposed within the void.

A foot assembly 16 may be configured to be slidably positioned along a track 12. A foot assembly 52 may be configured to slide along a track 12 in the Z-direction. A position of a foot assembly 16 along a track 12 may be adjustable such as to adjust a height of a beam 14 within a cargo trailer 20. The height of the beam 14 may include a distance between the beam 14 and the floor 24 of the cargo trailer 20. A foot assembly 16 may include a first state (e.g., a locked state) and/or a second state (e.g., an unlocked state). A foot assembly 16 may be fixed to and/or unable to move relative to a track 12 in the first state and/or may be configured to move along a track 12 in the second state. While the system 10 is shown including eight foot assemblies, the system 10 may comprise more or less than eight foot assemblies according to teachings of the present disclosure. Further, while FIG. 1 shows just one system 10 having one beam 14 and pair of foot assemblies 16 located within a track 12, it will be appreciated that a plurality of beams 14 with its respective foot assemblies 16 may be positioned on a given track 12. Such arrangement allows for multiple cargo loads 21 to be stacked vertically within the interior space of a trailer 20.

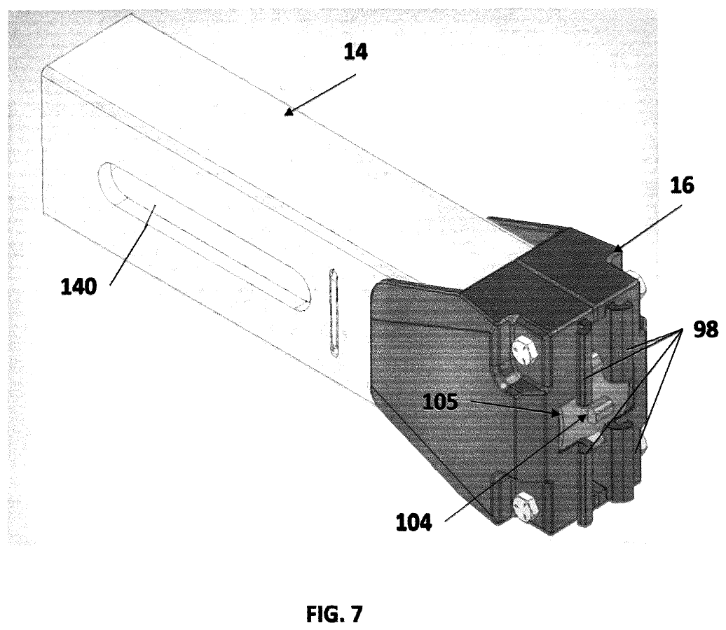

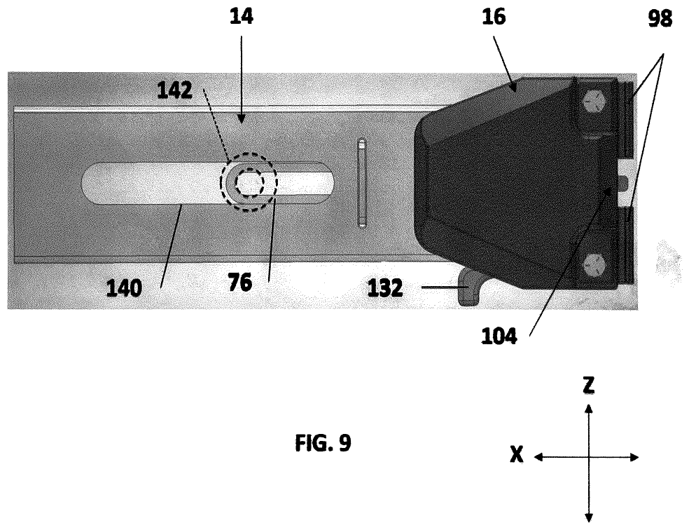

With continued reference to FIG. 3, a plate 50₁, 50₂ may include a first end 90, a second end 92 spaced apart from the first end 90, an outer surface 94, and/or an inner surface 96 disposed opposite the outer surface 94. The second end 92 of a plate 50₁, 50₂ may be configured to engage a track 12. For instance, a plate 50₁, 50₂ may include one or more elongated L-shaped portions 98 that are configured to engage a track 12 (see, e.g., FIGS. 7 and 9). The L-shaped portions 98 may extend from and/or along the second end 92 of a plate 50₁, 50₂.

As shown in FIG. 3, an inner surface 96 of a plate 50₁, 50₂ may include a plurality of indentations 100 such as a first indentation 100₁, a second indentation 100₂, and/or a third indentation 100₃. An indentation 100 may include a variety of shapes, sizes, and/or configurations. In some configurations, the first indentation 100₁ may be connected to and/or in communication with the second indentation 100₂.

As generally illustrated in FIGS. 3-5, a power balancer assembly 52 of a foot assembly 16 may include a spring 58, a spring case 60, one or more spring case covers 62, one or more spring case cover clips 64, a drive rod 66, one or more drive rod retention stops 68, and/or one or more drive rod bushings 70. The power balancer assembly 52 allows each foot assembly 16 to slidingly engage the track 12 in one instance and then to be locked to said track 12 in another instance. In some example configurations, the spring case 60 may include a cylindrical body 102 and/or a plurality of teeth 104. The teeth 104 may extend from and/or be disposed about the body 102. The teeth 104 may be evenly spaced about the body 102. The teeth 104 may be configured to engage a track 12. For instance, the teeth 104 may engage the openings 30 of a track 12. In an assembled configuration, the plates 50₁, 50₂ may define a void 105 such that the teeth 104 are accessible via the void 105 to engage a track 12 (see, e.g., FIG. 7).

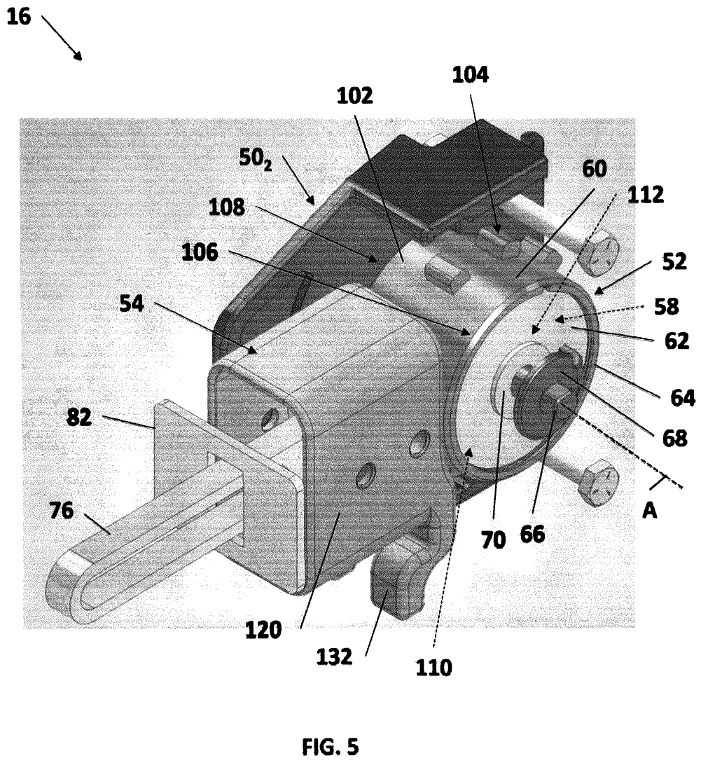

As seen in FIG. 5, a body 102 of a spring case 60 may include a first end 106, a second end 108 spaced apart from the first end 106, and/or an interior cavity 110 accessible via the first or second ends 106, 108. The spring 58 may be disposed within the cavity 110 and/or the drive rod 66 may be at least partially disposed within the cavity. A spring case cover 62 may be disposed at each end 106, 108 of the body 102 such as to enclose the spring 58 within the body 102. A spring case cover 62 may include a void 112 and the drive rod 66 and/or a drive rod bushing 70 may be at least partially disposed within the void 112. A spring case cover clip 64 may be configured to secure (e.g., fix) a spring case cover 62 to the body 102.

With continued reference to FIGS. 3-5, the drive rod 66 may include ends 114 that may be received by the third indentations or bosses 100₃ of the plates 50₁, 50₂. In some example configurations, the third indentations 100₃ may include a shape that is substantially similar to a shape of the ends 114 of the drive rod (e.g., cylindrical, circular, among others). The drive rod 66 may be disposed along and/or configured to rotate about an axis A (FIG. 5). The spring case 60 may be disposed about at least a portion of the drive rod 66. A rotation of the drive rod 66 may correspond to a rotation of the spring case 60.

With reference to FIG. 5, a drive rod retention stop 68 may be disposed about at least a portion of the drive rod 66 and/or proximate each end 114 of the drive rod 66. A drive rod retention stop 68 may be configured to engage a plate 50₁, 50₂ such as to stop rotation of the drive rod 66 and/or the spring case 60 if the foot assembly 16 reaches a predetermined position. A drive rod bushing 70 may be disposed about at least a portion of the drive rod 66 and/or adjacent each end 114 of the drive rod 66. A drive rod bushing 70 may be at least partially disposed between a spring case cover 62 and a drive rod retention stop 68.

A power balancer assembly 52 may be configured to rotate about the axis A. In some example configurations, a power balancer assembly 52 may be configured to bias a foot assembly 16 into the first state (e.g., a locked state) such as to secure (e.g., prevent from moving) a foot assembly 16 to a track 12.

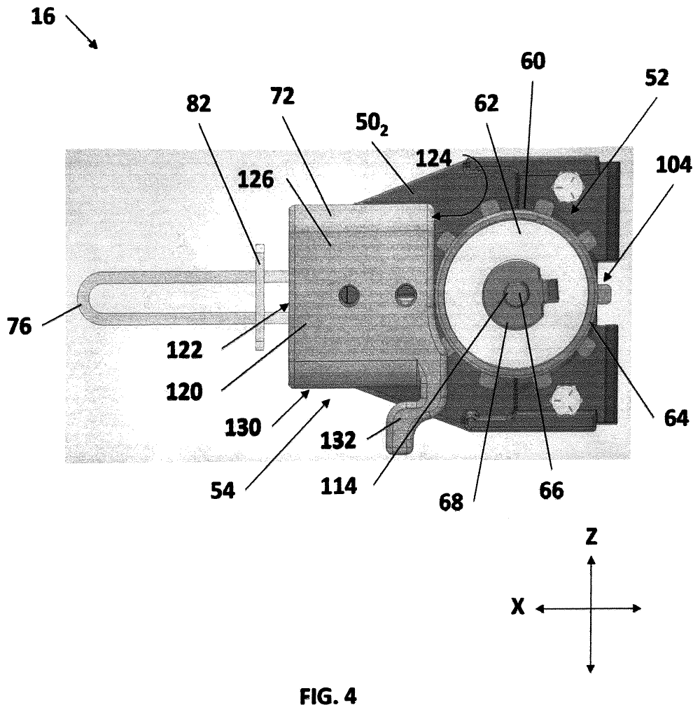

As shown in FIGS. 3-4, a release assembly 54 of a foot assembly 16 may include a locking lug 72, a locking lug spring 74, a release arm 76, a release arm attachment 78, one or more articulating unlock pins 80, and/or a spring retainer plate 82. A release assembly 54 may be configured to switch a foot assembly 16 from the first state (e.g., the locked state) to the second state (e.g., the unlocked state) such that the foot assembly 16 may move relative to a track 12 so that a height of a beam 14 may be easily adjusted by an operator without the need for any tools or other accessories, and with the use of only one operator. Thus, less manpower is needed in order to operate the system 10 which is beneficial where there is a manpower shortage.

A locking lug 72 may include a body 120 having a first end 122, a second end 12₄ spaced apart from the first end 122, a first side 12₆ extending between the first and second ends 122, 12₄, a second side 12₈ spaced apart from the first side 12₆, and/or a third side 130 extending between the first and second sides 12₆, 12₈. In some instances, the first and second ends 122, 12₄ may be open such as to allow access to an interior cavity of the body 120. One or more release tabs 132 may extend from the third side 130 of the body 120. The first and second sides 12₆, 12₈ may include through holes 134. The through holes 134 of the first side 12₆ may correspond and/or be aligned with the through holes 134 of the second side 12₈. The locking lug 72 may be configured to move relative to the power balancer assembly 52 (e.g., in the X-direction) (see, e.g., FIG. 4). For instance, the locking lug 72 may be disposed adjacent to and/or may engage the power balancer assembly 52 (e.g., the spring case 60) when a foot assembly 16 is in the first state (e.g., the locked state) defining a first position of the locking lug 72. The locking lug 72 may be moved away from and/or may be disengaged from the power balancer assembly 52, via a user of the system 10, when a foot assembly 16 is in the second state (e.g., the unlocked state) defining a second position of the locking lug 72.

The locking lug spring 74 may be disposed within the body 120 of the locking lug 72. The locking lug spring 74 may be configured to bias the locking lug 72 into the first position. The spring retainer plate 82 may be disposed adjacent to the first end 122 of the body 120 and/or may be configured to bias the locking lug spring 74 in the body 120. The spring retainer plate 82 may include a void 136. The release arm 76 may be at least partially disposed within the body 120 and/or the void 136 of the retainer plate 82. The release arm 76 may be elongated and/or may extend in a direction away from the body 120.

The release arm attachment 78 (e.g., a pin) may at least partially be disposed within the body 120 of the locking lug 72, a through hole 134 of the first side 126 of the body 120, and/or a through hole 134 of the second side 128 of the body 120. In some example configurations, the release arm attachment 78 may be connected to the release arm 76.

The release assembly 54 may include a first articulating unlock pin 80₁ and/or a second articulating unlock pin 80₂. The first pin 80₁ may be at least partially disposed within the body 120 and/or a through hole 134 of the first side 12₆ of the body 120. The second pin 80₂ may be at least partially disposed within the body 120 and/or a through hole 134 of the second side 12₈ of the body 120. A terminal end of a pin 80₁, 80₂ may extend from the body 120 such as to engage (e.g., be disposed within) the first and/or second indentations 100₁, 100₂ of a plate 50₁, 50₂. For instance, the first pin 80₁ may engage the first plate 50₁ and/or the second pin 80₂ may engage the second plate 50₂. A foot assembly 16 is configured such that a terminal end of a pin 80₁, 80₂ may only be disposed within the first and/or second indentations 100₁, 100₂ of a plate 50₁, 50₂.

With reference to FIG. 3, when the foot assembly 16 is in the first state (e.g., the locked state), the release assembly 54 is configured such that the terminal ends of the pins 80₁, 80₂ are disposed within the second indentation 100₂. While a foot assembly 16 is in the second state (e.g., the unlocked state) the release assembly 54 is configured such that the terminal ends of the pins 80₁, 80₂ are disposed within the first indentation 100₁. The indentations 100₁, 100₂ may be arranged such that the terminal ends of the pins 80₁, 80₂ move from the second indentation 100₂ to the first indentation 100₁ when a user manipulates the locking lug 72 (e.g., when a user applies a force to the release tabs 132) from the first position to the second position. The indentations 100₁, 100₂ may be arranged such that the terminal ends of the pins 80₁, 80₂ move from the first indentation 100₁ to the second indentation 100₂ when a user manipulates a beam 14 to a predetermined position. For instance, when a beam 14 is positioned approximately perpendicular (e.g., 90 degrees) relative to a track 12.

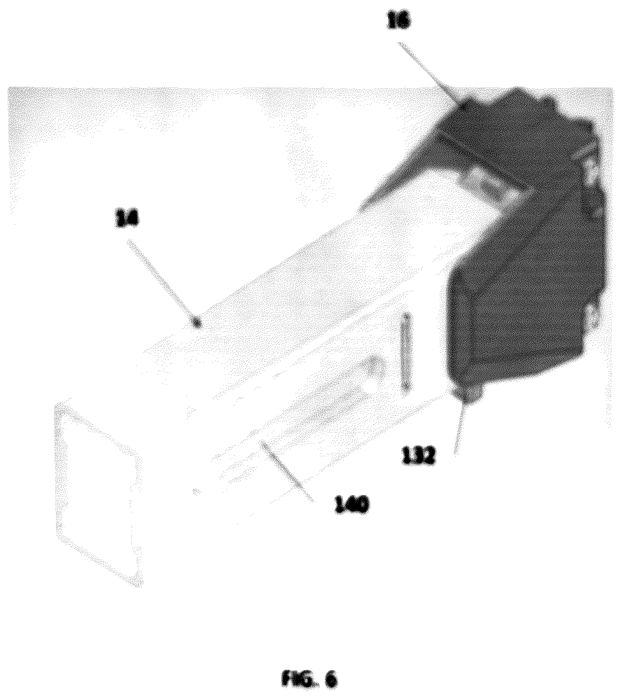

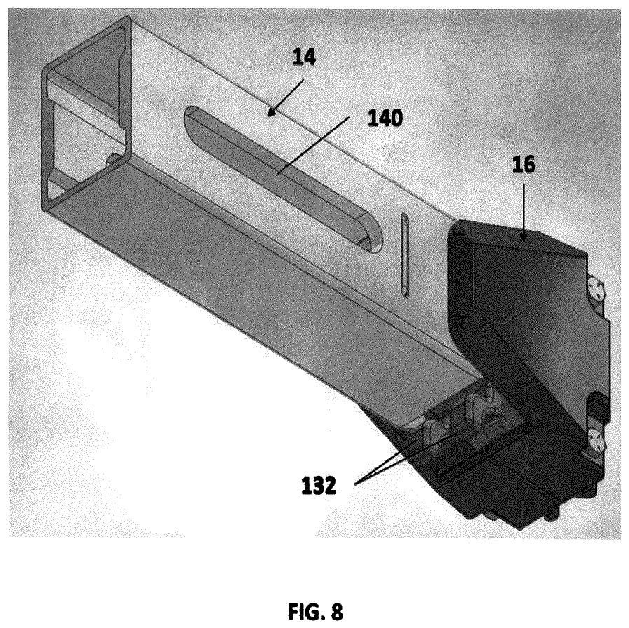

In the embodiments, such as generally illustrated in FIGS. 6-9, a foot assembly 16 is shown disposed proximate a terminal end of a beam 14. The foot assembly 16 is shown at least partially disposed within the beam 14. The beam 14 may be configured to move to an angle a (e.g., approximately 10-80 degrees and/or 100-170 degrees) (see, e.g., FIG. 1) relative to a track 12 when the foot assembly 16 is in the second state.

With reference to FIG. 9, a beam 14 may include voids 140 disposed on opposing side walls. The voids 140 may be aligned with a release arm 76 of the release assembly 54. A fastener 142 may be at least partiality disposed within the voids 140 such that a portion of the release arm 76 engages and/or wraps around a portion of the fastener 142. In some instances, if a beam 14 moves away from a foot assembly 16 (e.g., while an operator is adjusting a height of a beam) by a predetermined distance, the fastener 142 is configured to engage a terminal end of a void 140, such that the release arm 76 is configured to pulled a locking lug 72 of the release assembly 54 into an unlocked position and the foot assembly 16 is able to move relative to a track 12. A beam 14 may be coupled to a foot assembly 16 in part via a fastener 142.

A user of a system 10 may desire to adjust the height of one or more beams 14, for example and without limitation, to accommodate for various cargo 21 sizes. The system 10 is configured such that a single user may easily, safely, and efficiently adjust a height of a beam 14 while standing proximate one end 40, 42 of the beam 14. The system 10 is configured such that a user may manipulate a foot assembly 16 and/or beam 14 in numerous ways to adjust a height of a beam 14.

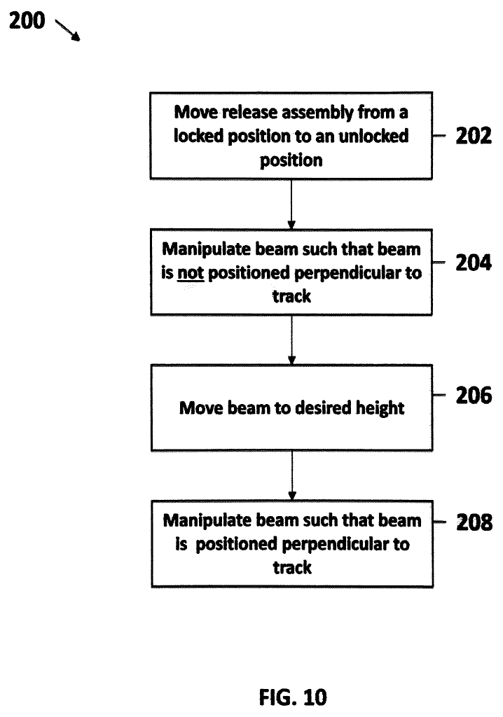

An example of one method 200 for adjusting a height of a beam 14 is generally illustrated in FIG. 10. The method 200 may include a user (e.g., an operator) moving a release assembly 54 of a first foot assembly 16 (e.g., 16₁) from a locked position to an unlocked position (block 202). For instance, the user may move a release table 132 of a locking lug 72 (e.g., of the first foot assembly 16 from the first position (e.g., a locked position) to a second position (e.g., an unlocked position). The release tab 132 may be easily manipulated by a user imparting motion on same by using his or her hand.

The method 200 may next include the user manipulating the beam 14 connected to the first foot assembly 16 such that the beam 14 is not positioned perpendicular to the track 12 that the first foot assembly 16 is connected to (block 204). For instance, the user may apply a downward or upward force (e.g., in the Z-direction) to the beam 14 (e.g., proximate one end 40, 42 of the beam 14) such that the beam 14 is moved away from being positioned perpendicular to the track 12. For example, and without limitation, the beam 14 may be moved such that the beam 14 is positioned approximately 10-80 degrees and/or 100-170 degrees relative to the track 12 (see, e.g., FIG. 1). When the beam 14 is moved to the position that is not perpendicular to the track 12, a second foot assembly 16 (e.g., 16₂) that is connected to the opposing end of the beam 14 may be configured to automatically switch from a locked state to an unlocked state.

For instance, as the first foot assembly 16 is unlocked via the user, the user will subsequently slide the first foot assembly 16 and/or the beam 14 relative to the track 12, as the second foot assembly 16 remains stationary. As the first foot assembly 16 moves along the track 12, a distance between the first and second foot assemblies 16 will increase. If the distance between the first and second foot assemblies 16₁ reaches a predetermined distance, the second foot assembly 16₂ is configured to automatically switch into an unlocked state. For example, a fastener 142 is configured to reach a terminal end of a void 140 of the beam 14 such that a release arm 76 of the second foot assembly 16 is configured to automatically pull the second foot assembly 16 into the unlocked state. For example and without limitation, the system 10 is configured such that a distance between the foot assemblies 16 when a beam 14 is at a position that is not perpendicular to the track 12 is greater than a distance between the foot assemblies 16 when the beam 14 is at a position that is perpendicular to the track.

The method 200 may next include the user moving the beam 14 to a desired height (block 206). For instance, the user may slide the beam 14 and the first and second foot assemblies relative to the track 12 until the desired height is reached.

The method 200 may next include the user manipulating the beam 14 such that the beam 14 is once again positioned perpendicular (e.g., approximately 90 degrees) relative to the track 12 (block 208). For instance, when the beam 14 is positioned perpendicular to the track 12, the first and second foot assemblies are configured to automatically switch from the unlocked state to the locked state. Thus, the method 200 contemplates a user being able to easily manipulate the system 10 relative to the track 12, and then the foot assembly 16 locking in place with the track 12, once a desired vertical height is achieved. Such is achieved without the use of external tools or without the need of multiple users.

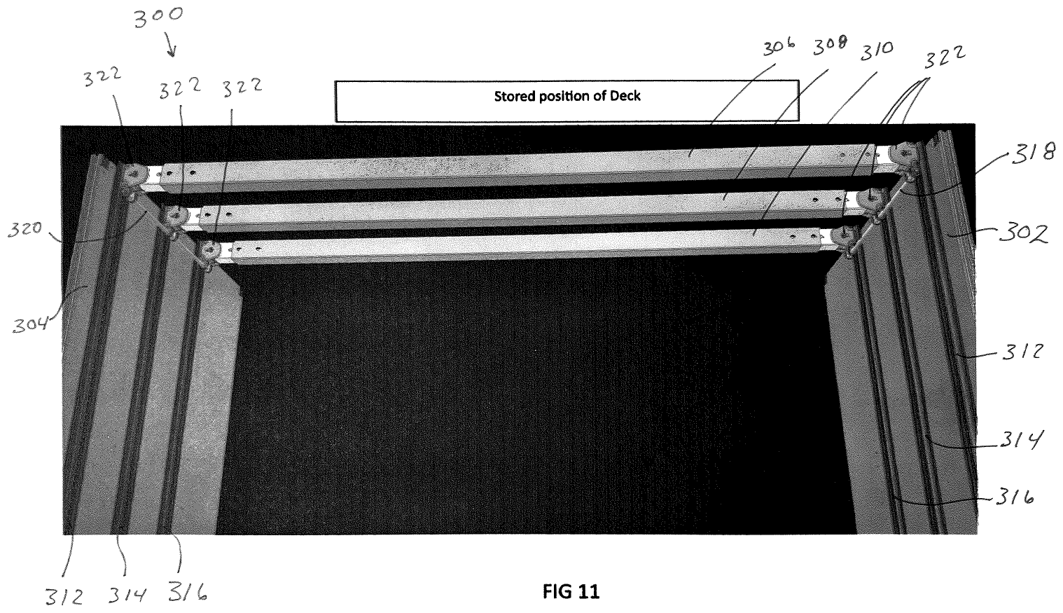

FIGS. 11-27 present an alternative decking system 300.

FIG. 11 illustrates an alternative deck leveling system 300, shown in a stored position, where three beams are connected together, and they are operable to move together relative to a track system mounted to side walls of a trailer. The system 300 may be used in a cargo trailer (not shown) for use with hauling cargo for merchants and others. Where possible, reference numerals will be used that were set forth in the systems above.

The system 300 may include a first wall 302 and a second wall 304 that could be sidewalls of a cargo trailer. The system shown has three beams and three sets of tracks, but it will be appreciated that more or fewer beams and tracks can be used with system 300. A first beam 306, second beam 308, and third beam 310 are slidingly connectable to first track 312, second track 314, and third track 316, respectively. Each beam can be manipulated to move relative to said tracks by pulling downwardly on a release arm 318 as shown on the right side, and/or by pulling on the release arm 320 as is shown on the left side. Each release arm connects to an adjacent foot assembly 322. The beams are shown in their horizontal position and are located at or near the top of the tracks. This could be an example of a first mode where the beams could be stored when the cargo trailer is empty.

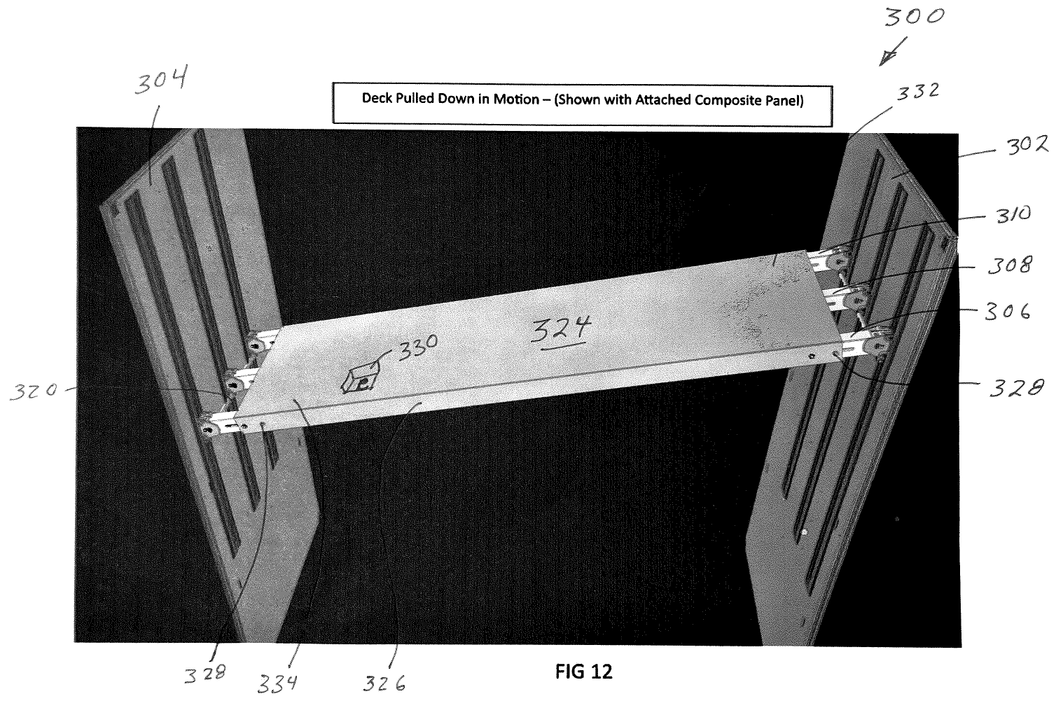

FIG. 12 is the deck leveling system 300, shown in a second mode, where a composite panel/platform 324 is shown in the pulled down position. In this second mode of operation, a panel of material 326 covers the top surface and side surfaces of the beams 306, 308 and 310, which collectively form the composite panel 324 which may include the foot assemblies 322. This arrangement creates a unitary panel 324 that moves in unison. The beams 306, 308 and 310 are secured to the material 326 by mounting arrangements 328. The mounting arrangements 328 may include fasteners that pass-through holes in the side surface of the panel 324 and secured to the beams. This arrangement forms a rigid structure and ties the three beams together. In this second mode, the panel 324 can move relative to first wall 302 and second wall 304. Cargo 330 may be placed on top of the panel 324 and secured using straps or other means (not shown). It will be appreciated that a deck system may include a unitary assembly where a panel, plurality of beams and foot assemblies are connected together and work in concert with one another to movingly engage a set of tracks on the walls of a cargo trailer. Motion may be imparted to one end of the unitary assembly by adding pressure to a single release arm that is connected to the foot assemblies. Likewise, motion may be imparted to another end of the unitary assembly by adding pressure to a single release arm that is located at the other end of said assembly. Once the release arm is motivated, the unitary assembly may be adjusted upwardly or downwardly.

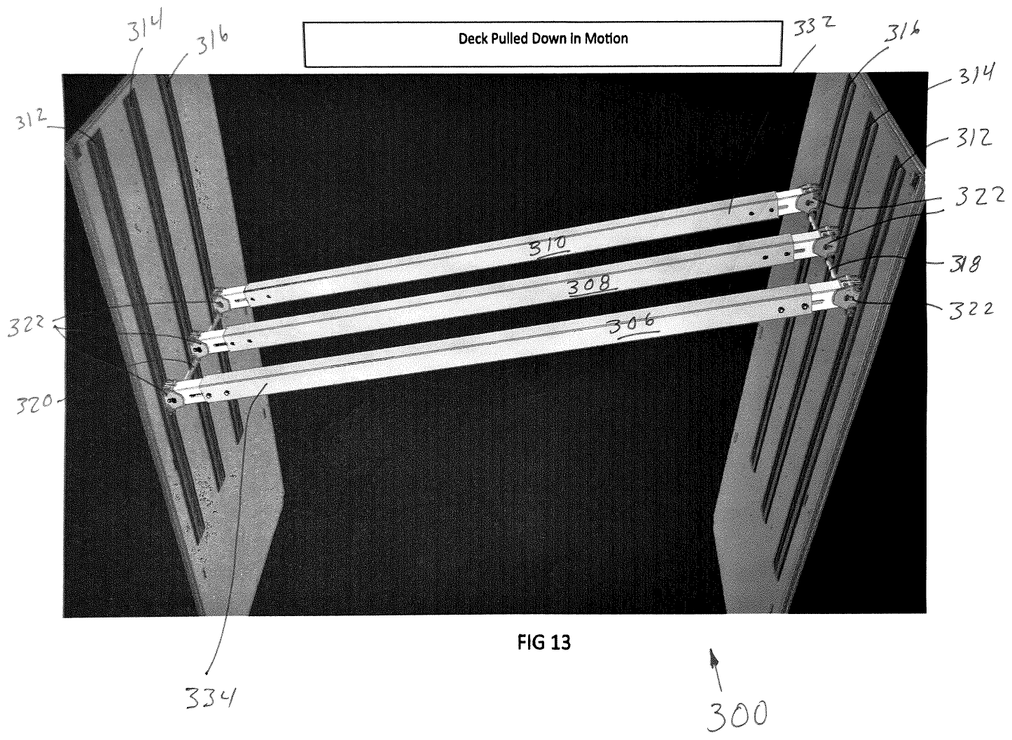

FIG. 13 is the deck leveling system 300, shown with three beams in a pulled down position, without the panel 324. In this third mode of operation, the right end 332 of the of beams are upward and the left end 334 of the beams are in a lowered position. This mode is a transition mode where an operator is positioning the set of three beams to a desired height based on the location the operator would like the beams to rest. If the operator wants the cargo to set higher in the trailer, then the beams may be adjusted upwardly. If the operator wants the cargo to be positioned lower in the tailer, the beams will be set at a lower position. The positioning is accomplished by the operator pulling downward on each release arm 318 and 320, and the operator imparting motion on the beams in an upward or downward direction. To reach a leveled, horizontal position, the operator moves both ends 332 and 334 to a horizontal position where the foot assemblies 332 of each beam then lock relative to their respective tracks.

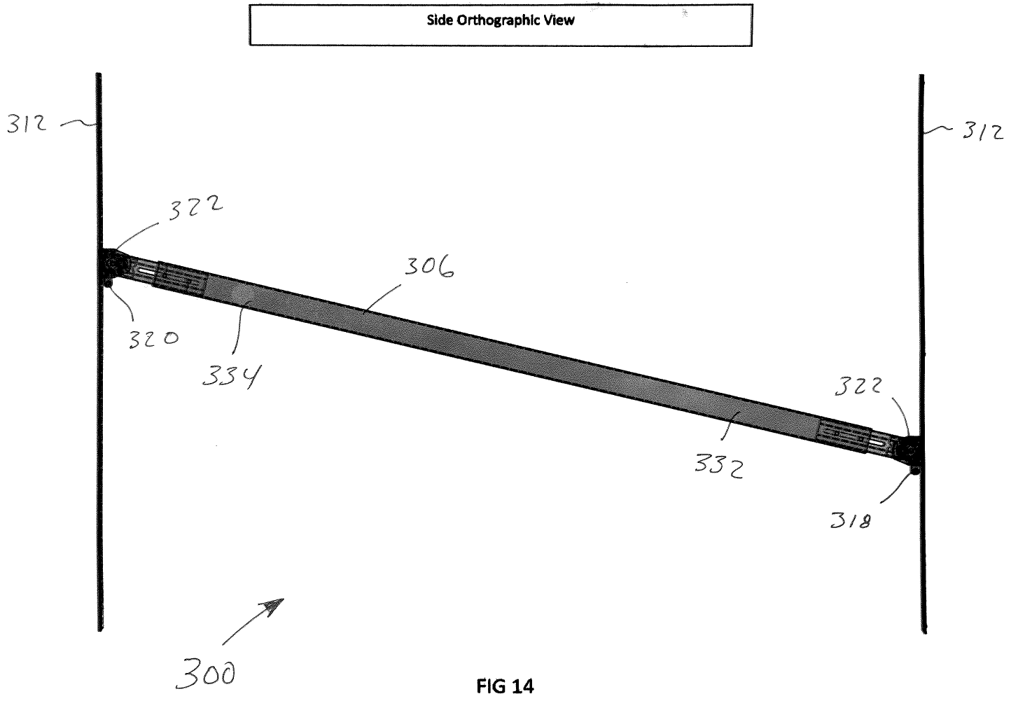

FIG. 14 is a side view of the deck leveling system 300, showing a beam 306 connected to two tracks 312 which may in turn be secured to sidewalls of a cargo trailer. Beam 306 is shown in the transitional mode where the operator has pulled the release arms 318 and 320 and moved the right end 332 downwardly and the left end 334 upwardly. In this mode, the foot assembly 322 on each end of the beam 306 moves freely and easily relative to the tracks 312. Very little force is required in this mode to motivate the beam 306 in either the upward or downward directions. As the beam 306 moves, the foot assemblies 322 move in and out of the inside diameter of the beam 306. The foot assemblies 322 move telescopically relative to the beam 306, all the while maintaining connectivity to the tracks 312.

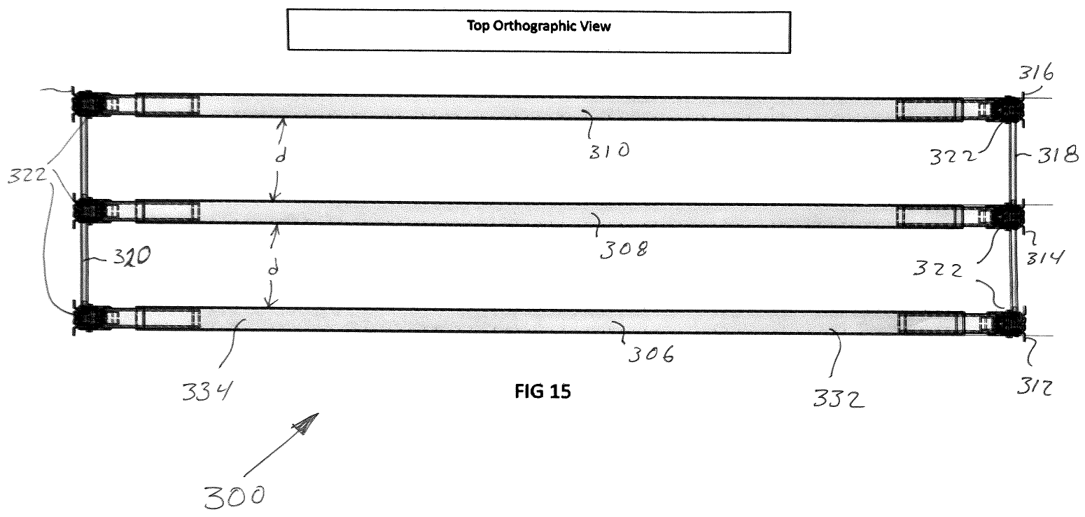

FIG. 15 is a top view of the deck leveling system 300, showing three beams 306, 308 and 310 mounted to three tracks 312, 314 and 316 that could be in turn mounted to the side walls of a cargo trailer or other structure (not shown). The release bar 318 extends laterally through each foot assembly 322 and connects the foot assemblies. When the operator pulls down on the release bar 318, it causes all three beams 306, 308 and 310 to be simultaneously unlocked from their respective tracks 312, 314 and 316. This allows the end 332 to move freely relative to the tracks if bar 318 is pulled. If bar 320 is pulled, this allows end 334 to move freely relative to the tracks. Each beam is spaced apart a distance d. The distance d may be altered based on the weight distribution preferences and load requirements.

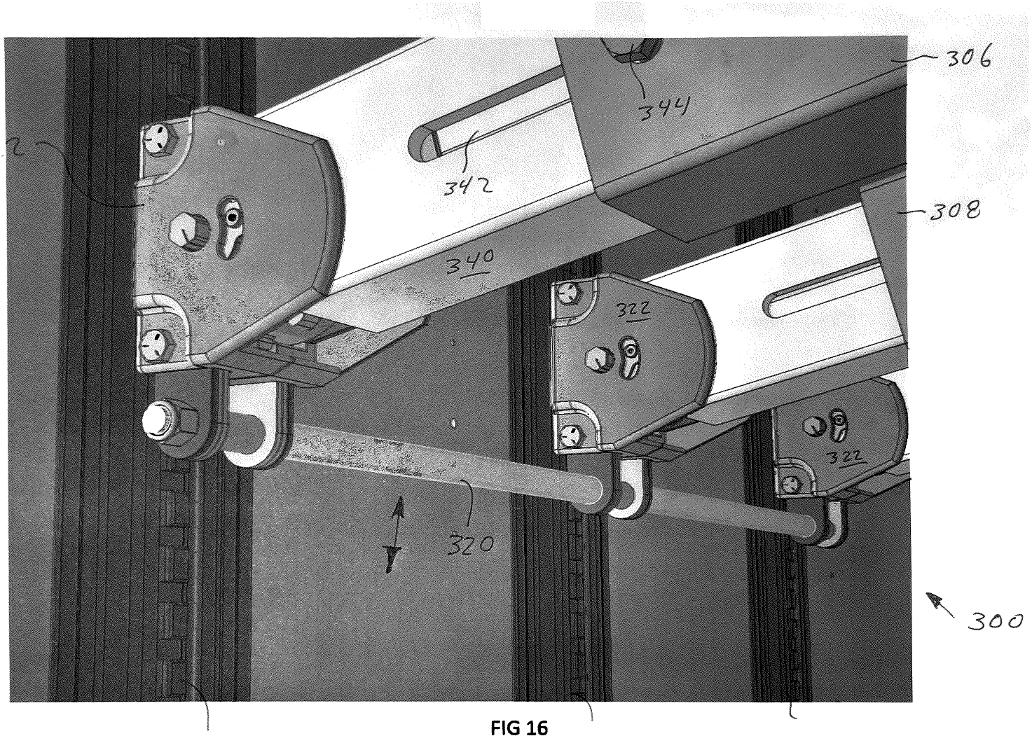

FIG. 16 is a perspective view of the foot assemblies 322 connected to beams, wherein the foot assemblies 322 are shown mounted to three vertical tracks positioned on a vertical wall of one side of a cargo trailer. Each foot assembly 322 has a sliding channel 340 that extends inside a beam. A slot or void 342 extends along a length of the sliding channel 340. The slot receives a bolt 344 that extends through the beam 306 which aids in providing the telescoping action between the foot assembly 322 and the beam 306. To unlock the beam 306 from the track 312, the operator pulls down on release arm 320 in the direction of the arrow which in turn simultaneously releases the beams from their respective tracks. The beams are now free to traverse the tracks upwardly or downwardly.

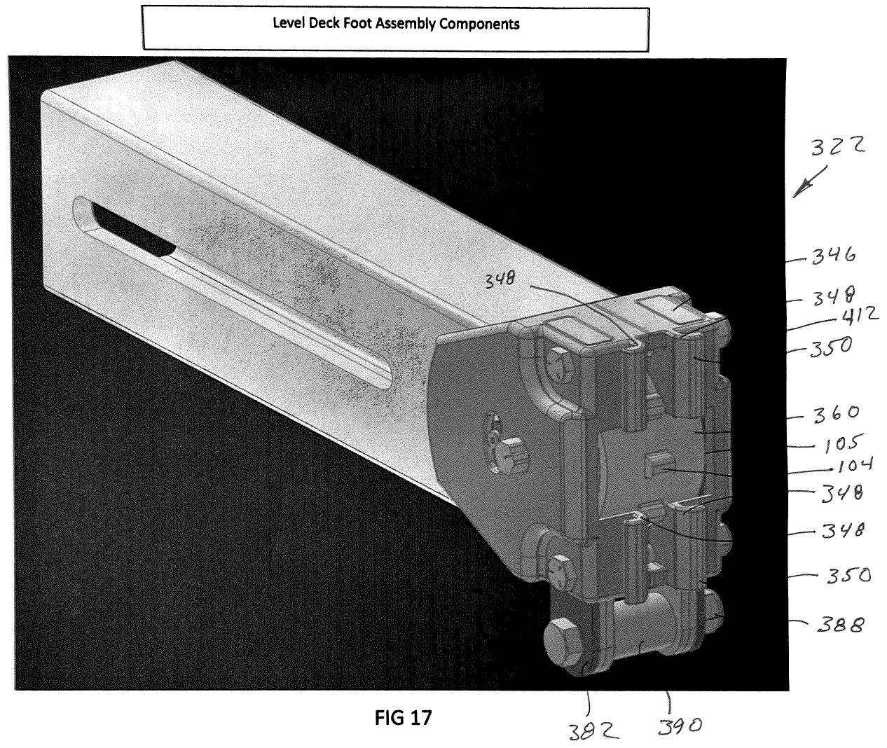

FIG. 17 is a perspective view of the foot assembly 322 from the opposite direction of FIG. 16. Here the back of the foot assembly 322 is shown with its features for connecting to the track. The foot assembly 322 includes a foot 346 with a void 105 which provides an opening for teeth 104 to extend outwardly for engaging the track. The foot 346 may be in two pieces and they include on a back wall a set of vertically extending curved retainers 348 that are configured to engage the track. Four curved retainers 348 are shown and they each have an outwardly extending member 350 for engaging a portion of the track (not shown). This arrangement allows each foot assembly 322 to slide vertically within or relative to the track.

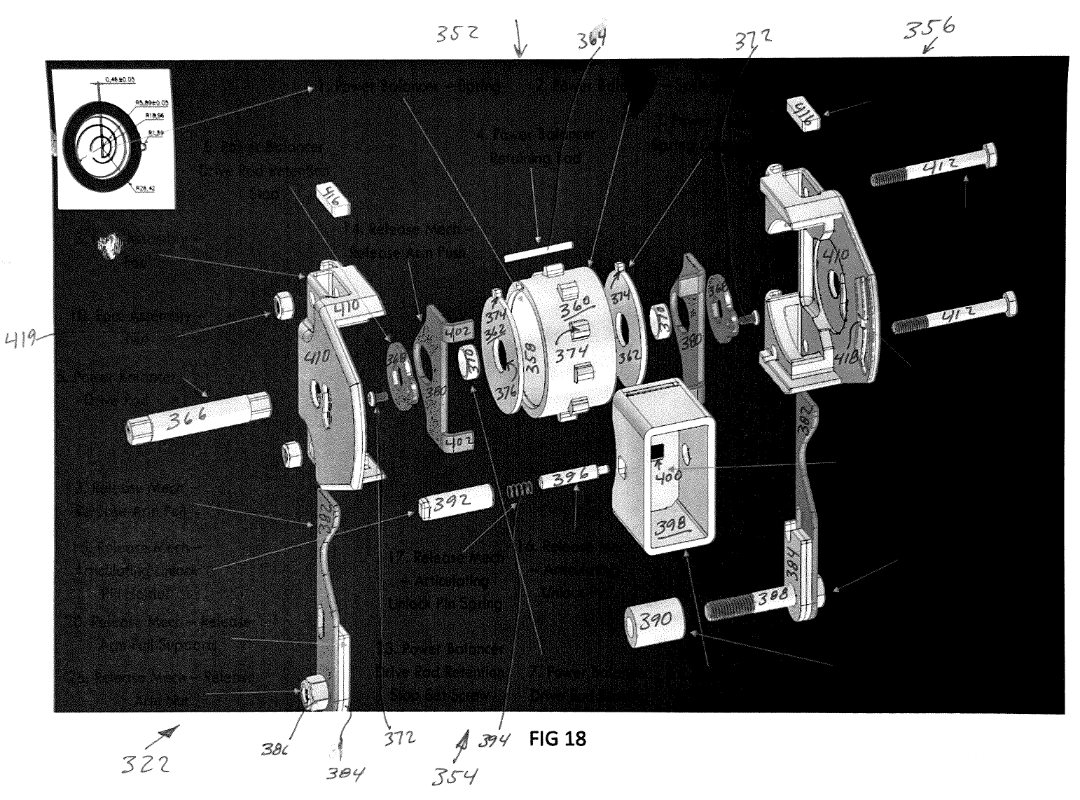

FIG. 18 is an exploded perspective view of the components of a foot assembly 322 that is used with the system 300. The foot assembly 322 may include as series of components that collectively work in concert to allow dynamic performance of the foot assembly 322. The foot assembly includes a power balancer 352, a release mechanism 354, and foot components 356. The power balancer 352 includes a power balancer spring 358, a spring case 360, a spring cover 362, a retaining rod 364, a drive rod 366, a drive rod retention stop 368, a drive rod bushing 370, and a drive rod retention stop set screw 372. The power balancer 352 may be made of metal or other similar structural material so as to provide structural integrity of the balancer 352.

The spring case 360 is circular in configuration and has plurality of teeth 374 extending outwardly about the circumference of the case 360. The teeth are operable to engage a track that is mounted to a cargo trailer. A spring cover 362 is provided on each side of the spring case 360 and helps to maintain the spring 358 within an inner diameter of the spring case 360. A tab 374 is provided on the spring case cover 362 and is configured to be received within a recess in the spring case 360. A pair of drive rod bushings 370 are received within a bore 376 of the spring case cover 362 and the drive rod 366 extends through the bushings 370.

The release mechanism 354 provides the function of allowing the foot assembly 322 to move relative to a track in the cargo trailer. The release mechanism 354 includes a release arm push 380, a release arm pull 382, a release arm pull support 384, a release arm nut 386, a release arm bolt 388, a release arm pull spacer 390, an articulating unlock pin holder 392, an articulating unlock pin spring 394, an articulating unlock pin 396, a release mechanism locking lug 398, and a slot 400 in the locking lug 398. The release arm 380 has a pair of outwardly extending tabs 402 and an opening that receives rod 366. The release pull arm 382 is elongated and the arm pull supports 384 may be welded or otherwise fixed to one side of the arm pull 382 and they provide a surface for the arm pull spacer 390 to abut against. The arm pull spacer 390 is what the operator may grasp to impart motion to the foot assembly 322.

The foot components 356 include a first and second foot 410, bolts 412, nuts 414, and top caps 416. The inside surface of each foot 410 has a ramp 418 located therein. The foot components 356 are made of metal or other similarly rigid and durable material.

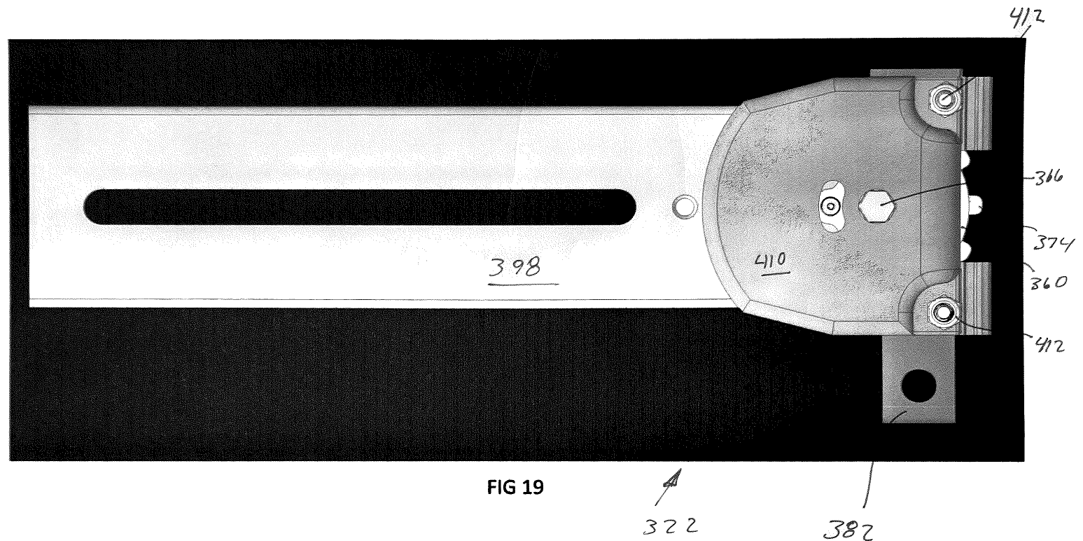

FIG. 19 is a side view of a foot assembly 322. The sliding channel 398 extends outwardly from the foot 410. The geometrically shaped drive rod 366 is affixed to a bore of the foot 410. Bolts 412 extend through the foot 410 and connect the two foot 410 pieces together. The release arm pull 382 extends downward from the foot 410.

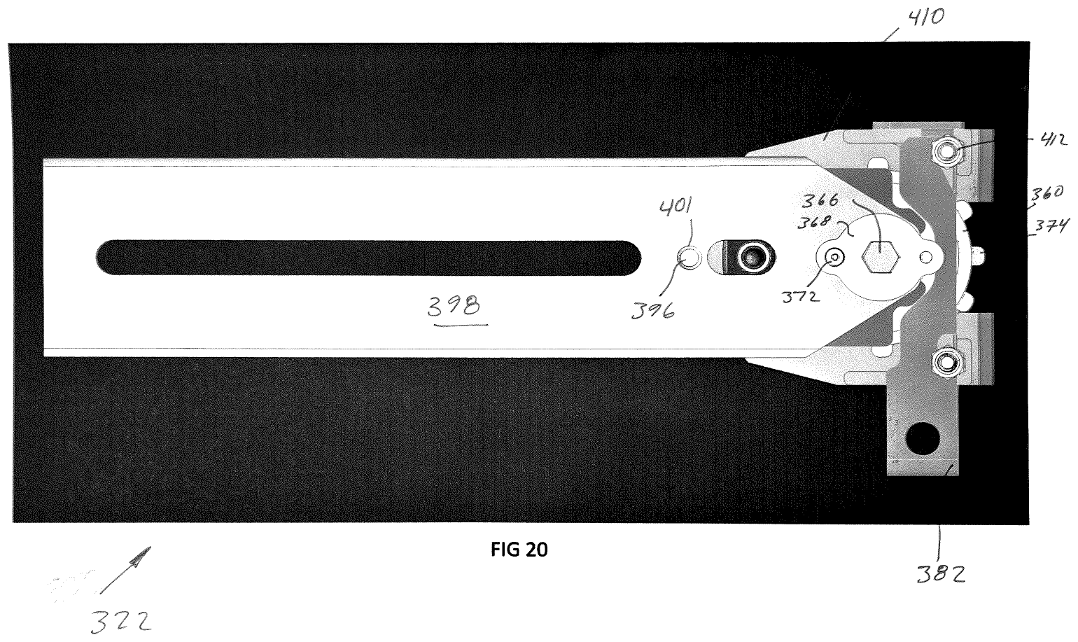

FIG. 20 is a side view of a foot assembly 322, with one foot 410 removed, so as to show internal components of the arrangement. The rectangle shaped sliding channel 398 has an opening 401 for receiving the pin 396. The drive rod 366, retainer stop 368 and screw 372 are configured to work together. The bolts 412 are shown connected to the foot 410 on the back side of the assembly. The teeth 374 on the spring case 360 extend out of the housing of the foot 410 far enough to be able to engage a track (not shown). To operate the foot assembly 322, the operator pulls down on the release arm 382 which in turn releases the sliding channel 398 from the power balancer 352. This in turn allows the teeth 374 that were engaged with the adjacent track, to move freely as it is now in an unlocked, free to move, mode of operation. In order to lock the teeth 374 relative to the track, the operator moves the sliding channel 398 to a horizontal position.

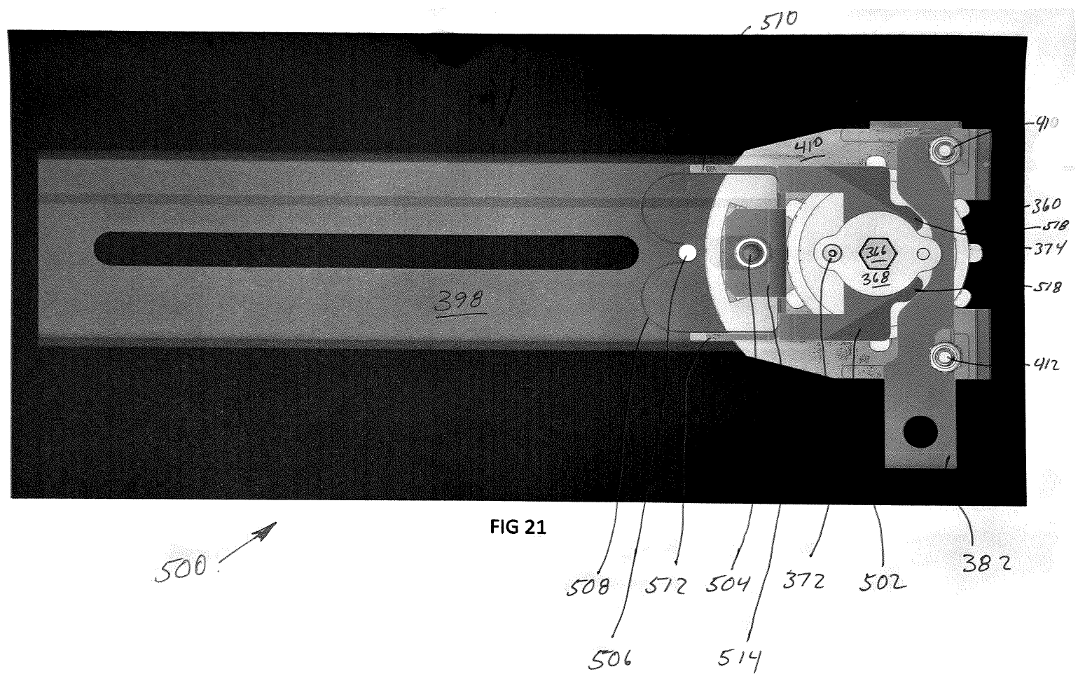

FIG. 21 is a side view of an alternative foot assembly 500, showing internal components. Where possible, similar reference numerals will be used for components mentioned above. This alternative foot assembly 500 includes a lock release mechanism 502, a spring plunger 504, a linear spring bar 506, and a linear retraction spring 508. The assembly 500 further includes a foot 410, drive pin 366, retainer 368, retention screw 372, an arm pull 382 with a multi-beam connector hole, bolts 412, and the spring case 360. The lock release mechanism 502 can be a stamped bracket having an upper flange 510, a lower flange 512, a side flange 514, and a slot 516 with outwardly extending arms 518. The arms are operable to advance relative to a bushing 370 (see FIG. 18). The linear retraction spring 508 is arcuate shaped and provides a biasing force against the inside surface of the locking lug 398.

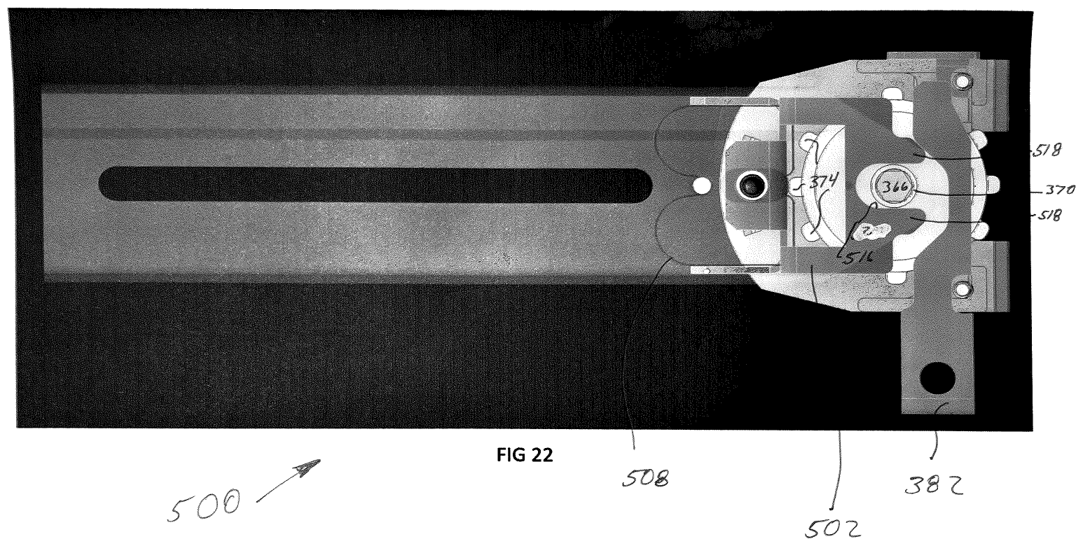

FIG. 22 is a side view of the foot assembly 500 that is shown in FIG. 21, but the retention stop 369 has been removed so as to show how the arms 518 work and are capable of moving in and out relative to the bushing 370.

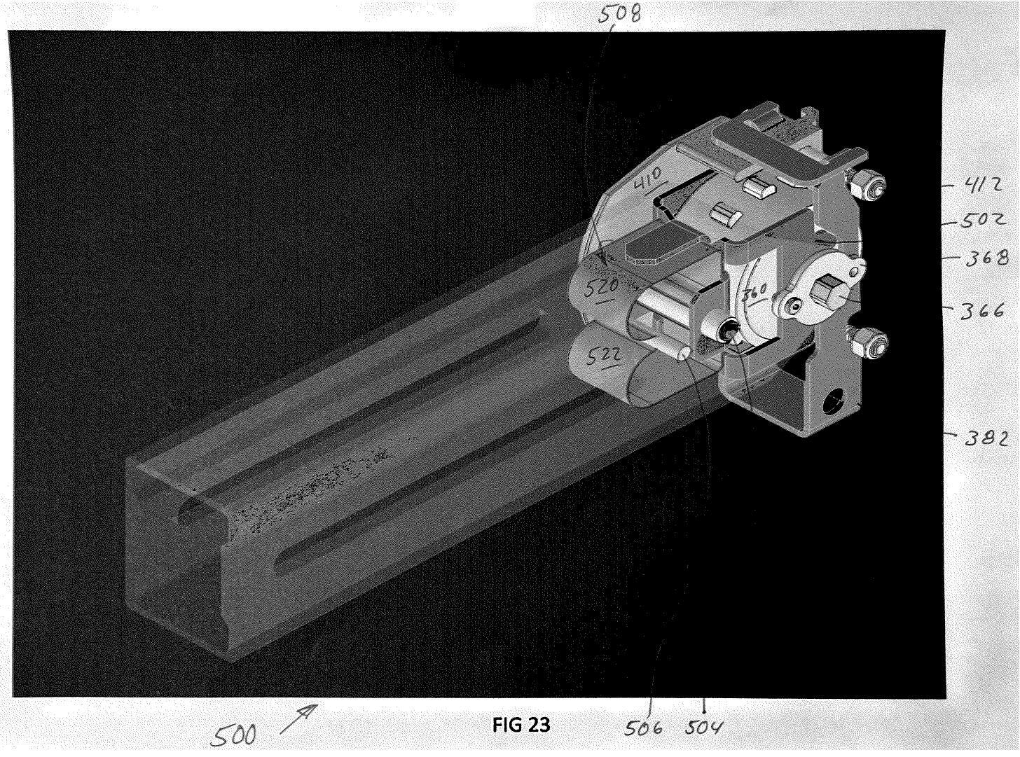

FIG. 23 is a perspective view of a foot assembly 500 with the stop 368 shown installed.

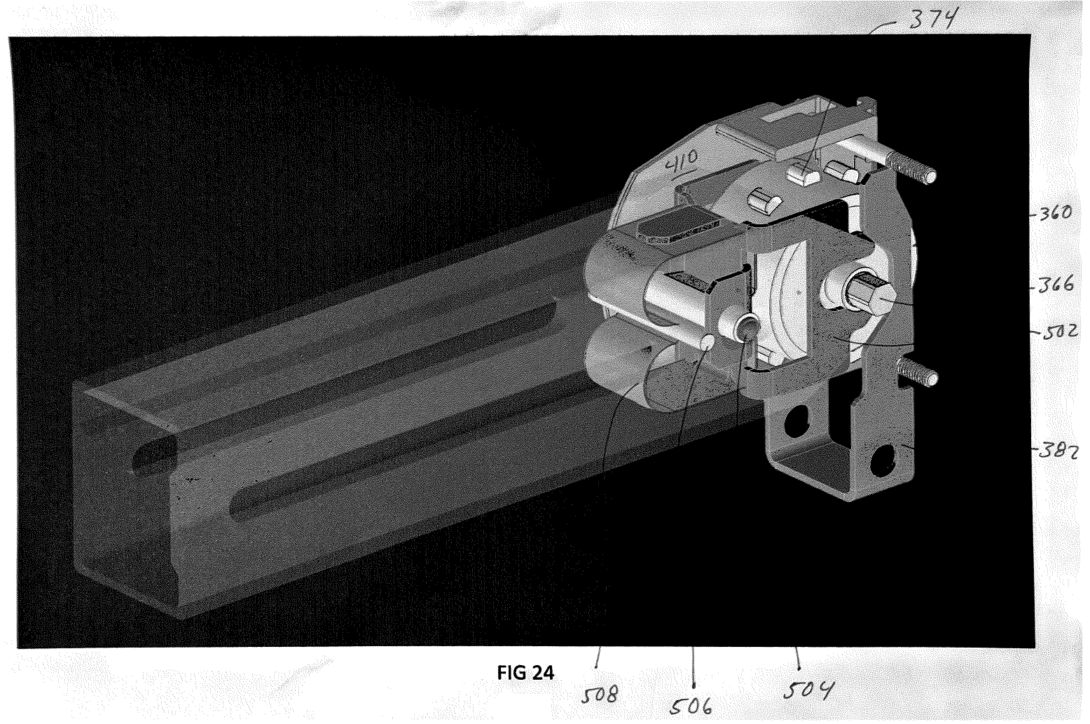

FIG. 24 is a perspective view of a foot assembly 500 with the stop 368 removed. The linear retraction spring 508 is metallic and it has a first portion 520 and a second portion 522 separated by the spring bar 506.

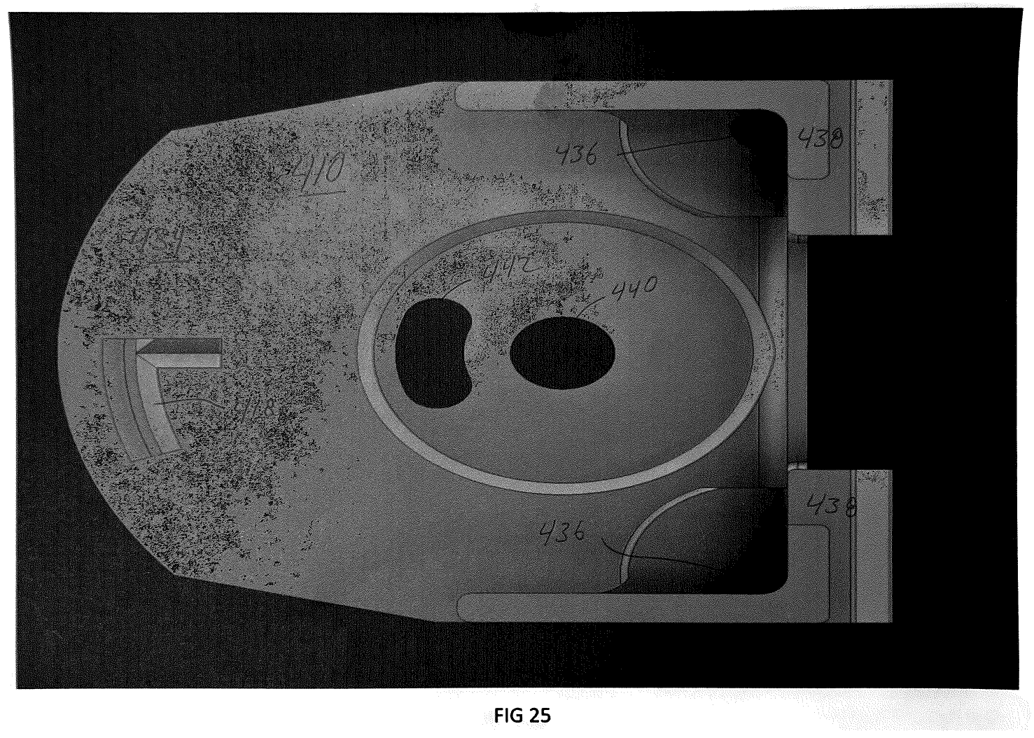

FIG. 25 is an inside view of one half of the housing for the foot 410 that is part of the foot assembly 322.

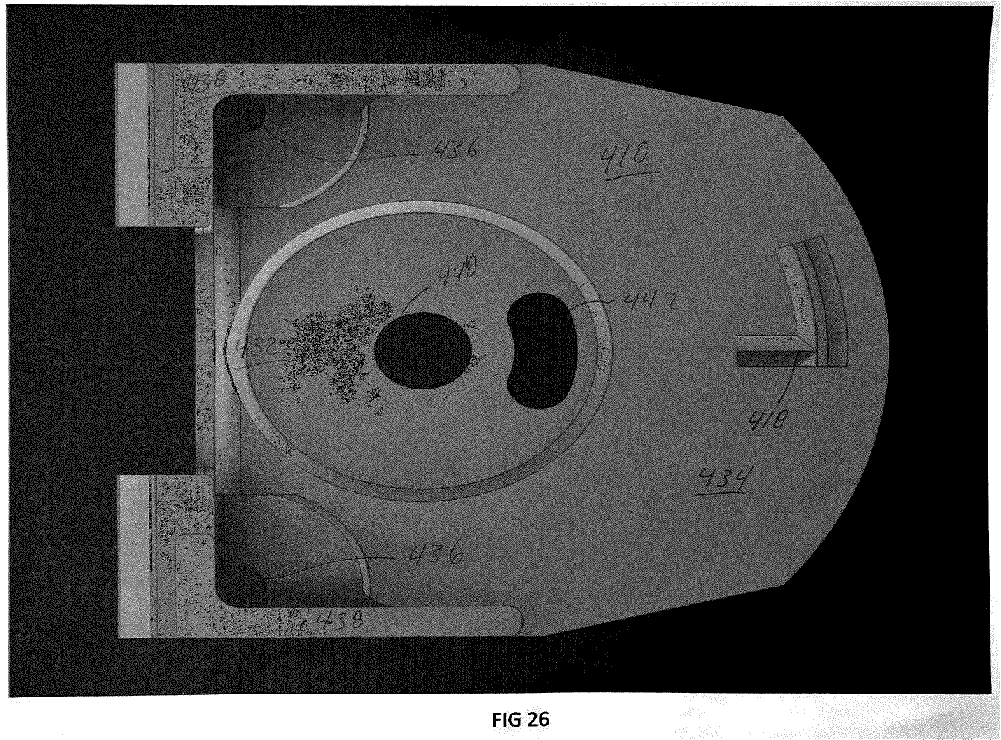

FIG. 26 is an inside view of the other half of the housing for the foot 410. Each foot assembly 322 has two foot 410 parts or halves that are bolted together. The foot 410 includes a wall 430 with a back portion 432 and an outwardly extending portion 434. A ramp 418 is in the outwardly extending portion 434 and is formed on its surface. The back portion 432 includes openings 436 for receiving bolts 412. Flanges 438 are located at the upper and lower areas of the back portion 432. The flanges 438 may be L-shaped. The top flange 438 has a recess (not shown) for receiving the top caps 416. A drive rod opening 404 is located centrally in the wall 430 and a slot 442 is located towards the extended portion 434.

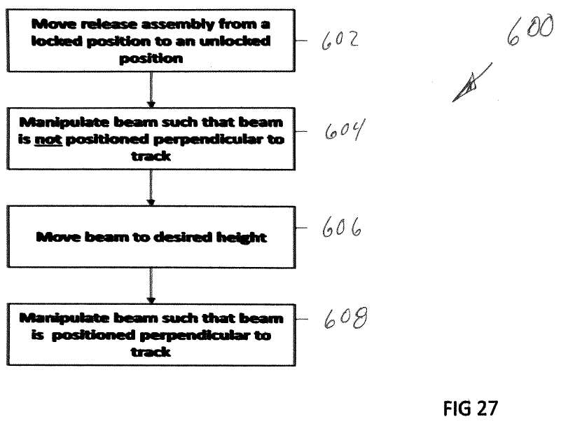

FIG. 27 is a flow chart of the method 600 of operating the deck leveling assembly mentioned herein. At step 602 the operator moves the release assembly from a locked position to an unlocked position. This is accomplished by the operator pulling downward on the arm pull 382 or arm pull spacer 390 which in turn releases the unlock pin 396 (see FIG. 18). This in turn allows the teeth 374 to disengage from the locking lug slot 400 that is in the back surface of the locking lug 398. Once the teeth 374 disconnects from the locking lug slot 400, the spring case 360 is free to rotate. This permits the foot assembly 322 to now move vertically relative to the track that may be mounted to a wall of a cargo trailer.

The next step is step 604 where the operator can now manipulate the beam such that the beam is no longer positioned perpendicular to the track.

The next step is step 606 where the operator can move the beam to a desired height within the cargo trailer. In this mode, the foot assembly 322 moves easily up and down while in the track. The beam may be placed at any location by moving the left side of the beam up or down, while moving the right side of the beam up or down. No tools are required during this adjustment phase of operation. Manipulate is tool free. Manipulation of the beam is simply done by the operator applying pressure on the top side, or lower side, of the beam. Once the beam is located to the desired height, the next step is implemented.

The final step of operation is step 608 and that occurs by the operator manipulating the beam such that it is positioned perpendicular to the track. Once in this position, the foot assembly 322 locks into place and is fixed relative to the track. When the beam is positioned perpendicular to the track, the teeth 374 engage the locking lug slot 400. This causes the spring case 360 to stop rotating. When the left side of the beam and the right side of the beam or both perpendicular to the track, the beam is now locked in place and ready for cargo to be placed thereon. This would represent a horizontal position of the beam.

In order to readjust the beam, the operator merely repeats steps 602, 604, 606 and 608.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such elements. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example, and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

What is claimed is:

1. A system comprising: a track;
a beam; and
a first and a second foot assembly connected to the beam and configured to move along the track;
wherein the beam and the first and second foot assembles are configured to move relative to the track when the first and second foot assembles are in an unlocked state;
the beam is positioned perpendicular relative to the track when the first and second foot assembles are in a locked state; and
the beam is in a position that is not perpendicular relative to the track when the first and second foot assembles are in the unlocked state.

2. The system of claim 1, wherein the first foot assembly is at least partially disposed within a first terminal end of the beam and the second foot assembly is at least partially disposed within a second terminal end of the beam.

3. The system of claim 1, wherein the beam is positioned approximately 10-80 or 100-170 degrees relative to the track when the first and second foot assembles are in the unlocked state.

4. The system of claim 3, wherein the beam is configured to support cargo; and
the system includes one or more external components configured to prevent the cargo from moving relative to the beam.

5. The system of claim 1, wherein the first and second foot assembles each include: a first plate;
a second plate connected to the first plate such that a void is disposed between the first and second plates;
a power balancer assembly at least partially disposed within the void, the power balancer assembly is configured to bias the respective foot assembly into the locked state; and
a release assembly at least partially disposed within the void, the release assembly is configured to switch the respective foot assembly from the locked state to the unlocked state.

6. A method of operating a system, the method comprising:
moving a release assembly of one of a first foot assembly or a second foot assembly to an unlocked position;
manipulating a beam such that the beam is in a position that is not perpendicular to a track; moving the beam to a desired height; and
manipulating the beam such that the beam is positioned perpendicular to the track.

7. The method of claim 6, wherein manipulating the beam such that the beam is in a position that is not positioned perpendicular to the track includes a user applying a downward or upward force to the beam proximate a terminal end of the beam.

8. The method of claim 6, wherein the other one of the first foot assembly or the second foot assembly is configured to automatically switch into the unlocked state when the beam is in the position that is not perpendicular to the track and the first foot assembly is spaced apart from the second foot assembly by a predetermined position.

9. The method of claim 6, wherein moving the beam to a desired height includes sliding the first and second foot assemblies and the beam relative to the track.

10. The method of claim 6, wherein the first and second foot assemblies are configured to automatically switch from the unlocked state to the locked state when the beam is positioned perpendicular to the track.

11. A foot assembly,
comprising: a first plate;
a second plate connected to the first plate such that a void is disposed between the first and second plates;
a power balancer assembly at least partially disposed within the void; and
a release assembly at least partially disposed within the void, the release assembly is configured to switch the respective foot assembly from a locked state to an unlocked state.

12. The foot assembly of claim 11, wherein the foot assembly is configured to selectively move along a track.

13. The system of claim 1, wherein a release mechanism operates due to angle of force and not due to the extension of a beam.

14. The system of claim 1, wherein a mechanism is operable to retain a released section using bilateral symmetry of the interior portion of a clamshell foot design.

15. The system of claim 1, wherein a mechanism is operable to pre-tension a power spring during installation to maximize spring power while still allowing installation through an open port at a bottom of each track.

16. The system of claim 1, further comprising a detent that is integrated with a spring plunger to reduce frictional wear forces in the release mechanism.

17. The system of claim 1, further comprising a release handle mechanism that protrudes from the bottom of the foot assembly, the release handle mechanism is operable to permit a beam to be used in different formats such as a single beam, or to be integrated into two, three, or more beams to be moved in conjunction with one another.

18. The system of claim 1, further comprising a connecting bar that is operable to be connected to multiple beams, the beams are configured to be moved in conjunction with one another.

19. The system of claim 1, further comprising a fixed composite board that is mounted onto a multiple beam arrangement having zero beams or more than one beam, one beam, two beams, three beams, or a plurality of beams, so as to operate in a unitary manner.

20. The method of operating a deck system in a trailer for handling cargo, comprising:
moving a release assembly from a locked position to an unlocked position;
manipulating a beam such that the beam is not positioned perpendicular to a track,
moving the beam to a desired height within a cargo trailer, and
manipulating the beam such that the beam is positioned perpendicular to the track.
